(19) United States
(12) Patent Application Publication
(10) Pub. No.: US 2026/0370398 A1
(43) Pub. Date: Nov. 19, 2026

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingstoke (GB); Shin Horng WONG, Basingstoke (GB); Vivek SHARMA, Basingstoke (GB); Yuxin WEI, Basingstoke (GB)

(73) Assignee: Sony Group Corporation, Tokyo (JP)

(21) Appl. No.: 19/477,838

(22) PCT Filed: Mar. 27, 2024
(86) PCT No.: PCT/EP2024/058329

§ 371 Date: Oct. 23, 2025

(30) Foreign Application Priority Data
May 9, 2023 (EP) 23172398.2

(51) Int. Cl. H04L 1/1867; H04L 1/1812; H04W 24/04; H04W 72/21; H04W 72/542

(52) U.S. Cl. CPC H04L 1/1887; H04L 1/1819; H04W 24/04; H04W 72/21; H04W 72/542

(57) ABSTRACT

Methods, infrastructure equipment and communications devices for robustly signalling whether retransmissions are required for a particular uplink transmission occasion. A communications device indicates in an earlier uplink occasion whether retransmissions are required for a particular uplink transmission occasion and an infrastructure equipment selectively schedules uplink resources for retransmissions based on the indication from the communications device. If the infrastructure equipment is unable to determine whether retransmissions are required for a particular uplink transmission occasion, the infrastructure equipment schedules the uplink resources for the particular uplink transmission occasion.

The present application claims the Paris Convention priority of European patent application EP23172398.2, filed 9 May 2023, the contents of which are hereby incorporated by reference.

### BACKGROUND

### Field of Disclosure

The present disclosure relates to infrastructure equipment, communications devices, and methods for the transmission and/or reception of data by an infrastructure equipment in a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, eXtended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is eXtended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### SUMMARY OF THE DISCLOSURE

The present disclosure can help address or mitigate at least some of the issues discussed above.

According to a first aspect there is provided: a method of operating an infrastructure equipment forming part of a wireless communications network configured to transmit signals to and/or to receive signals from a communications device via a wireless access interface, the method comprising: monitoring an uplink channel for a transmission from a communications device during a first uplink transmission occasion; attempting to decode the transmission from the communications device in the first uplink transmission occasion; attempting to identify a first retransmission indicator associated with the first uplink transmission occasion; and determining, based on the attempting to identify the first retransmission indicator associated with the first uplink transmission occasion, whether or not to schedule uplink resources on the uplink channel for one or more retransmissions of the transmission, wherein if the infrastructure equipment is unable to identify a retransmission indicator associated with the first uplink transmission occasion, the infrastructure equipment schedules uplink resources for the communications device to transmit the one or more retransmissions of the first transmission that the infrastructure equipment fails to decode.

According to a second aspect, there is provided: a method of operating a communications device configured to transmit signals to and/or to receive signals from an infrastructure equipment of a wireless communications network via a wireless access interface, the method comprising: transmitting, to the infrastructure equipment and during a first uplink transmission occasion, an indication of whether transmissions in a second uplink transmission occasion occurring subsequent to the first uplink transmission occasion are to be retransmitted.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of an NR-type wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is reproduced from [8], and illustrates a traffic model for eXtended Reality (XR);

FIG. 5 illustrates the time-domain parameters for a Configured Grant of Physical Uplink Shared Channel (CG-PUSCH);

FIG. 6 demonstrates how Redundancy Version (RV) patterns restart during PUSCH repetitions;

FIG. 7 illustrates an example of a New Radio Unlicensed (NR-U) Channel Access on a grid of radio communications resources;

FIG. 8 illustrates an example of a main CG-PUSCH with two supplementary CG-PUSCHs;

FIGS. 9A-9C illustrates example teachings of the present disclosure, wherein an infrastructure equipment determines whether to schedule uplink resources for one or more retransmission by a communications device.

FIG. 10 illustrates an example approach for transmitting control information for an uplink transmission occasion in prior uplink transmission occasions.

FIG. 11 illustrates a flowchart of a method of operating an infrastructure equipment according to an example of the present disclosure.

FIG. 12 illustrates a flowchart of a method of operating a communications device according to an example of the present disclosure.

### DETAILED DESCRIPTION OF THE EMBODIMENTS

### Long Term Evolution Advanced Radio Access Technology (4G)

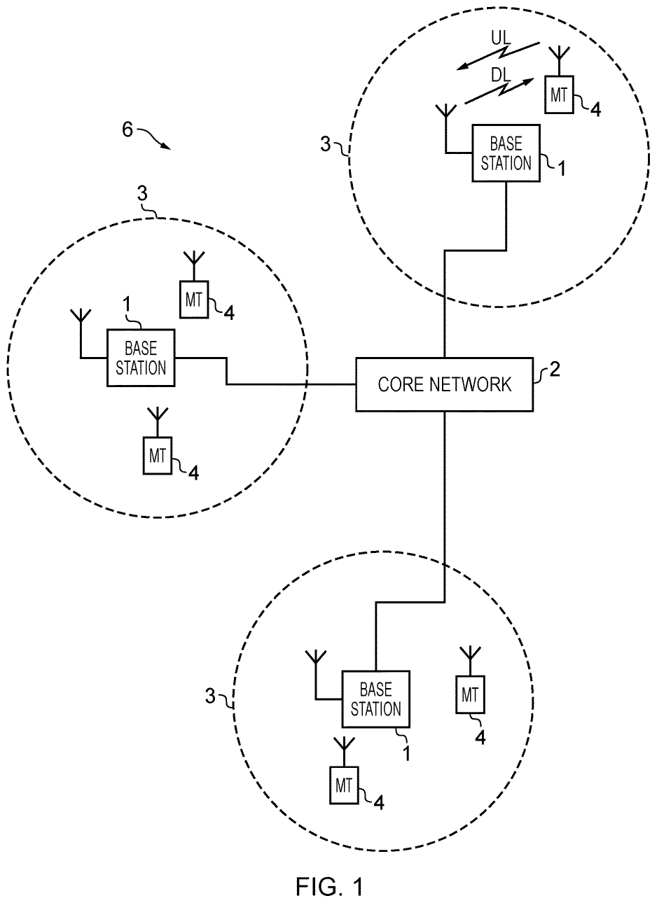

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e., a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e., page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

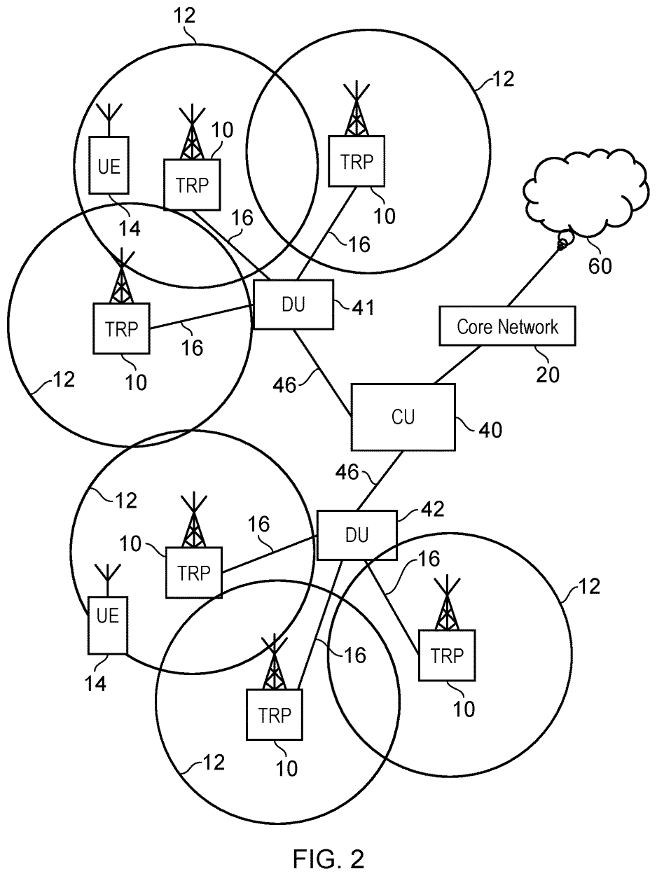

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

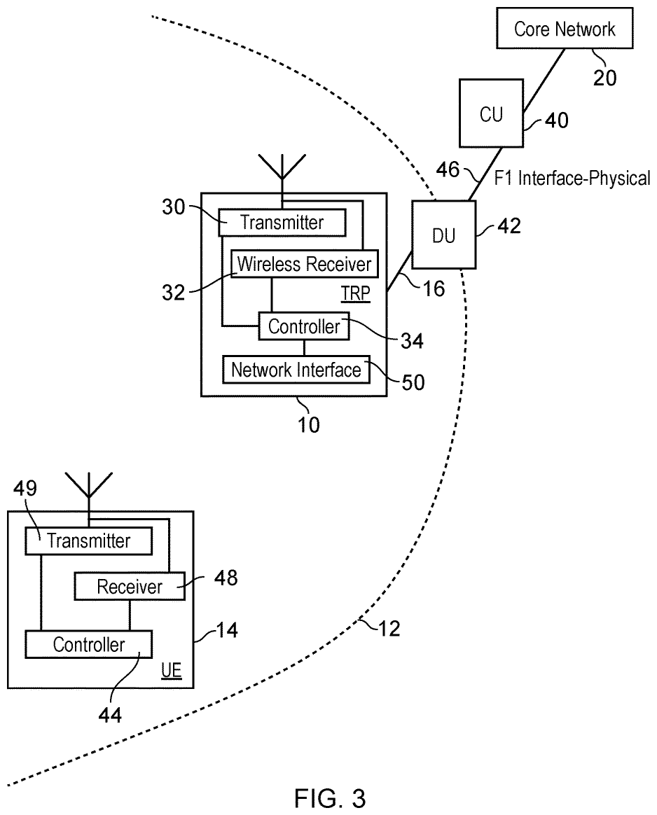

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

eURLLC, NR-U, and Extended Reality

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. A requirement for Ultra Reliable and Low Latency Communications (URLLC) services is that one transmission of a 32 byte packet is required to be transmitted from the radio protocol layer 2/3 SDU ingress point to the radio protocol layer 2/3 SDU egress point of the radio interface within 1 ms with a reliability of 1-10-5 (99.999%) or higher (99.9999%) [2]. Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] [4] specifies features that require high reliability and low latency, such as factory automation, transport industry, electrical power distribution, etc. It should be appreciated that the Uplink Control Information (UCI) for URLLC and eMBB will have different requirements.

Another such service incorporating NR technology is 5G NR in Unlicensed Spectrum (NR-U) [5], which enable devices to make use of shared and unlicensed spectrum bandwidth. Such features as Listen Before Talk (LBT), as specified by [5], is incorporated into the NR frame structure for NR-U operation in unlicensed bands.

eXtended Reality (XR) and Cloud Gaming refer to various types of augmented, virtual, and mixed environments, where human-to-machine and human-to-human communications are performed with the assistance of handheld and wearable end user devices (UEs). XR and Cloud Gaming are two more recently developed applications, that are considered important for NR Rel-18 and beyond (also known as 5G Advanced) [6].

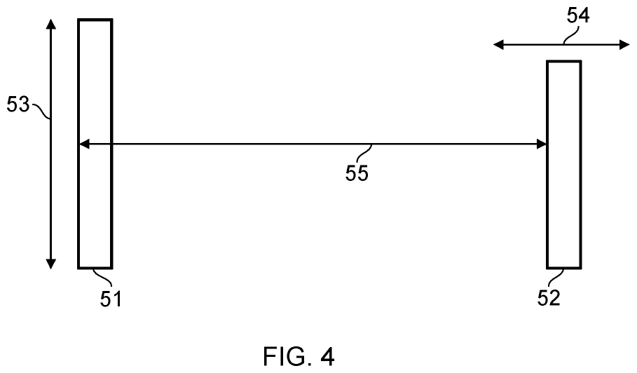

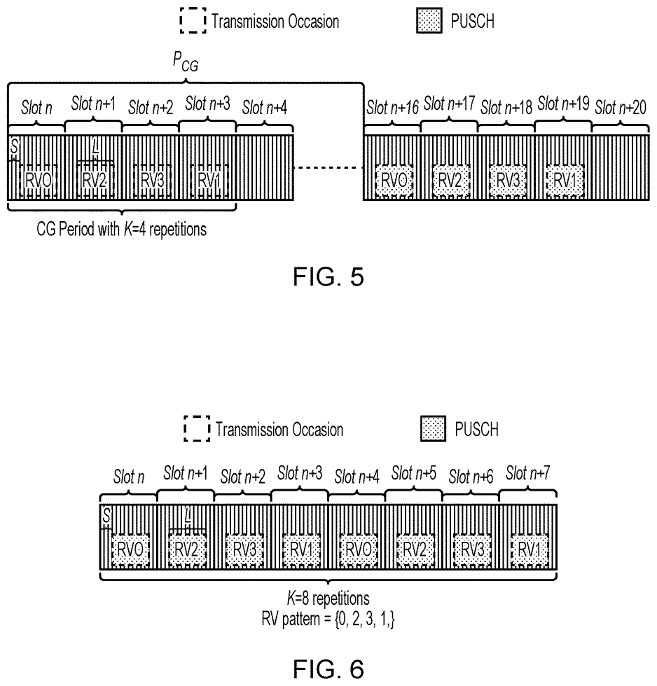

XR traffic is rich in video, especially in the downlink, with a typical frame rate of 60 Hz [7], which leads to a data transmission with non-integer periodicity in NR, i.e. the periodicity is not an integer number of subframes and in this example, the periodicity is 16.67 ms. Due to varying frame encoding delay and network transfer time, the packet arrival at the gNB may experience random jitter. The non-integer and jitter characteristics of XR traffic is known as quasi-periodic traffic. In addition to jitter, the packet size also varies within a range; that is the packet size in each period is random. The jitter and random packet size of UL traffic is illustrated in FIG. 4, which is based on a similar figure (FIG. 5.1.1-1) in [8].

FIG. 4 illustrates a single stream traffic model for XR. A first packet k 51 is transmitted, representing Internet Protocol (IP) packets belonging to video frame k. At a later point in time—which, on average, is the inverse of the frame generation rate (i.e., 1/fps) as denoted by arrow 55—a second packet k+1 52 is transmitted, representing IP packets belonging to video frame k+1. The variable packet size which follows a probability distribution is shown by arrow 53, while the variable jitter which also follows a probability distribution is denoted by arrow 54.

In the legacy 5G system, traffic with known periodicity and packet size, e.g. voice, is supported using Configured Grant of PUSCH (CG-PUSCH) and Semi-Persistent Scheduling (SPS) Physical Downlink Shared Channels (PDSCH). In the legacy system, CG-PUSCH (which is discussed in greater detail below) and SPS assume that the Transport Block Size (TBS) of the PUSCH and PDSCH of the traffic are the same in every period. However, in XR traffic, the payload of a quasi-periodic traffic may not be the same but varies within a range.

### Rel-15 Configured Grant

As is well understood by those skilled in the art, a UE uses a Physical Uplink Shared Channel (PUSCH) for uplink data transmission. The PUSCH resources used for the transmission of the PUSCH can be scheduled by a gNB using a Dynamic Grant (DG) or a Configured Grant (CG).

In a Dynamic Grant PUSCH (DG-PUSCH), the UE typically sends a Scheduling Request (SR) to the gNB when uplink data arrives at its buffer. In response to receiving the SR, the gNB would then send an Uplink Grant, e.g., via Downlink Control Information (DCI) using DCI Format 0_0, 0_1 or 0_2, carried by a Physical Downlink Control Channel (PDCCH) to the UE where this Uplink Grant schedules resources for a PUSCH. The UE then uses the scheduled PUSCH (i.e. DG-PUSCH) to transmit its uplink data.

It is observed that the use of DG-PUSCHs introduces latency, since the UE needs to initiate an SR and has to wait for an Uplink Grant before it is scheduled PUSCH resources. For regular and periodic traffic, DG-PUSCH would lead to multiple SR and Uplink Grants being sent which is not an efficient use of resources. Hence, recognising the drawbacks of DG-PUSCH, Configured Grant of PUSCH (CG-PUSCH) is introduced in NR. In CG-PUSCH, the UE is pre-configured using Radio Resource Control (RRC) configuration periodic PUSCH resources, such that the UE can transmit its uplink data in any of these regularly occurring CG-PUSCH resources without the need to request it with an SR. There are two types of CG-PUSCH:
Type 1 CG-PUSCH: Once the CG-PUSCH resource is configured by RRC, the UE can use it without activation; and
Type 2 CG-PUSCH: The CG-PUSCH resource is firstly RRC configured. The UE can only use the CG-PUSCH resource if it receives an activation DCI, which is an UL Grant with a Configured Scheduling-Radio Network Temporary Identifier (CS-RNTI). Once the CG-PUSCH is activated the UE can use it until it is deactivated by another DCI. Type 2 CG-PUSCH provides better control for the gNB scheduler and therefore more efficiently utilises resources.

In the time domain, a CG-PUSCH consists of a periodicity P_{CG}, repetitions K={1, 2, 4, 8}, duration L of the PUSCH and starting symbol offset relative to slot boundary S of the PUSCH. An example is shown in FIG. 5, where the CG-PUSCH has a periodicity P_{CG}=224 symbols (or 16 slots), repetition of K=4, duration of L=9 symbols and a starting symbol S=3 symbols from the start of slot boundary. The CG-PUSCH consists of Transmission Occasions (TO), where a TO is an opportunity for the UE to transmit uplink data. It should be noted here that the UE does not need to use a TO, i.e., a CG-PUSCH resource, if it has no uplink data to transmit. For example, in Slot n, the UE does not have any uplink data and so it does not transmit anything in the TOs for that CG period but in the next CG Period starting in Slot n+16, the UE has uplink data and therefore uses the TOs in that CG Period to transmit four repetitions of the uplink data.

The first TO in a CG Period is associated with Redundancy Version RV=0. If repetition K>1, then each TO in the CG Period is associated with an RRC configured RV pattern, where the RV pattern can be {0, 2, 3, 1}, {0, 3, 0, 3} or {0, 0, 0, 0}. The RV pattern is configured in RRC parameter repK-RV. For example, in FIG. 5, the RV pattern={0, 2, 3, 1}. The first PUSCH transmission in a CG Period must always start with RV=0. For repetition K=8, the RV pattern is cycled after the fourth repetition; i.e. the RV pattern restarts after the fourth repetition. For example, in FIG. 6, the RV pattern={0, 2, 3, 1} and K=8 repetitions. Here the UE cycles the RV at the fifth repetition, where the RV pattern is restarted at the fifth TO of the CG period in Slot n+4.

Since Hybrid Automatic Repeat Request (HARQ) is used for PUSCH transmission, each PUSCH is associated with a HARQ Process Number (HPN) where there are 16 HARQ processes, i.e., HPN=0 to 15. In DG-PUSCH, the HPN is indicated in the UL Grant. For CG-PUSCH, since there is no UL Grant, each CG period is associated with an HPN and is dependent upon the starting symbol O_{CG} (in units of symbols) of the first TO in a CG period relative to SFN=0, the periodicity P_{CG} (in units of symbols) and the number of HARQ processes N_{HARQ} configured for the CG-PUSCH [7] (i.e., the gNB can configured less than 16 HARQ processes for a CG-PUSCH), i.e.:

$$HPN = ⌊ \frac{{O}_{CG}}{{P}_{CG}} ⌋ MOD {N}_{HARQ}$$

Where └⋅┘ is the Floor function and O_{CG} is relative to the first symbol of the first slot of the radio frame with SFN=0.

Retransmission of a CG-PUSCH is scheduled using an UL Grant. That is, a DG-PUSCH is used for the retransmission of a CG-PUSCH that is not decoded successfully at the gNB. If the UE does not receive an UL Grant for the retransmission of a CG-PUSCH within a pre-configured timer T_{CG-ACK}, the UE will consider that the CG-PUSCH has been received successfully. The timer T_{CG-ACK}, is configured by RRC parameter configuredGrantTimer.

### Channel Access in NR-U

In the following paragraphs, an explanation is provided of current proposals for accessing communications from an unlicensed frequency band. In an unlicensed band, two or more systems may operate to communicate using the same communications resources. As a result, transmissions from different systems can interfere with each other especially when for example, each of the different systems are configured according to different technical standards, for example Wi-Fi and 5G. Of course, transmissions from systems operating in accordance with the same standard may also cause interference. As such, there is a regulatory requirement to use an LBT protocol for each transmitter operating in an unlicensed band to reduce interferences among different systems (either operating according to the same or different technical standards as one another) sharing that band. In LBT, a device that wishes to transmit a packet will firstly sense the band for any energy levels above a threshold to determine if any other device is transmitting, i.e. it listens, and if there is no detected transmission, the device will then transmit its packet. Otherwise, if the device senses a transmission from another device it will back-off and try again at a later time.

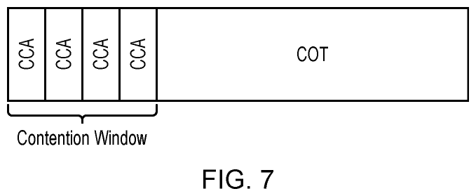

In NR-U the channel access can be Dynamic (also known as Load Based Equipment) or Semi-Static (also known as Frame Based Equipment). The dynamic channel access schemes consist of one or more Clear Channel Assessment (CCA) phases in a Contention Window followed by a Channel Occupancy Time (COT) phase as shown FIG. 7. LBT is performed during the CCA phase by an NR-U device (e.g. gNB or UE) that wishes to perform a transmission. According to the CCA phase, the NR-U device listens to one or more of CCA slots and if no other transmission is detected (i.e. energy level is determined to be below a threshold for the duration of the one or more CCA slots) after the CCA phase, the NR-U device moves into the COT phase where it can transmit its packet in the COT resources. In Dynamic Channel Access (DCA) the CCA and COT phases can be of different length between different systems whilst in Semi-static Channel Access, the CCA and COT phases have fixed time windows and are synchronised for all systems sharing the band. Further details on channel access in NR-U may be found in co-pending International patent application with international publication number WO 2022/018230 [9].

A COT can be shared by multiple devices; i.e. a gNB can initiate the COT which it can then share with one or more UE. For example, a gNB can initiate a COT, and then can transmit an UL Grant to a UE, and the UE can then use this COT to transmit the PUSCH. A device using a COT initiated by another device may not need to perform CCA, or may need to perform just a short CCA. Those skilled in the art would appreciate that a UE can also initiate a COT.

### CG-UCI

In Rel-15 and Rel-16 eURLLC, the HARQ Process Number (HPN) and Redundancy Version (RV) of each CG-PUSCH transmission is fixed for each TO, and is known to the gNB. However, in Rel-16 NR-U, the UE can use any of the TOs for a first PUSCH transmission, and different TBs (i.e. with different HPN) can be transmitted in a CG occasion, and therefore the gNB needs to know the HPN and the RV of these CG-PUSCH. In order to provide this information to the gNB, CG Uplink Control Information (CG-UCI) is introduced for Rel-16 NR-U, which consists of the following fields:
HARQ Process Number (HPN) (indicated by 4 bits);
Redundancy Version (RV) (indicated by 2 bits);
New Data Indicator (NDI) (indicated by 1 bit); and
COT sharing information (indicated by log₂C_{DL} bits, where COL is the number of entries in a lookup table indicating the locations of DL resources that the gNB can use within the UE initiated COT).

The CG-UCI is multiplexed into the CG-PUSCH transmission.

### Rel-18 Supplementary CG-PUSCH

Supplementary CG-PUSCH is proposed for NR in Rel-18, where additional CG-PUSCHs (i.e., supplementary CG-PUSCHs) can be configured for each of the multiple CG-PUSCHs, and these supplementary CG-PUSCHs can be dynamically activated using CG-UCI in the main (i.e., first) CG-PUSCH. Since the supplementary CG-PUSCHs are dynamically activated, they are only used if required. If they are not activated, the allocated resources can be reallocated by the gNB to schedule other traffic or UEs. The first CG-PUSCH transmission occasion within a period of the CG-PUSCH configuration is called main CG-PUSCH. The subsequent CG-PUSCH transmission occasion(s) within a period of the CG-PUSCH configuration are called supplementary CG-PUSCH(s).

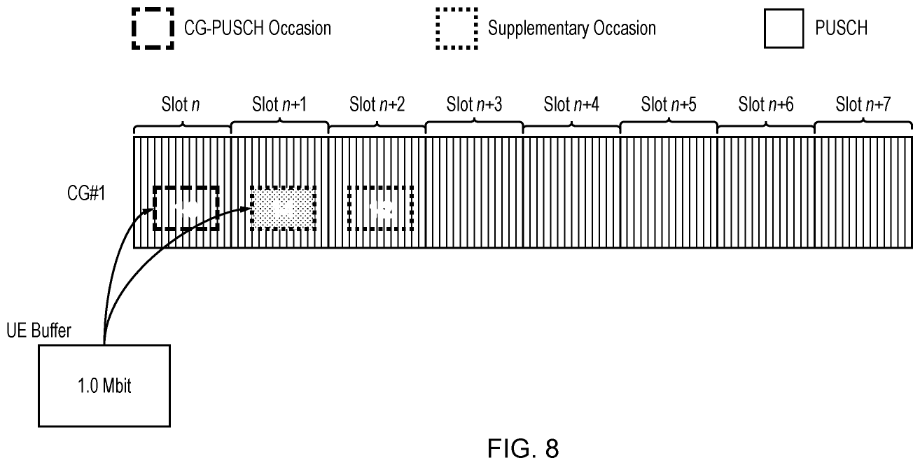

An example of this operation is shown in FIG. 8, where a UE is configured with a CG-PUSCH configuration, CG #1, with K=1 repetitions to support XR traffic. For XR traffic with a minimum TBS of 0.5 Mbits and a maximum TBS of 1.5 Mbits, in order to reduce resource wastage, the CG-PUSCH is configured with a TBS corresponding to the minimum XR packet size of 0.5 Mbit, and with two supplementary CG-PUSCHs (each also 0.5 Mbit in size), thereby allowing the main and supplementary CG-PUSCHs between them to support up to the maximum XR packet size of 1.5 Mbit, if required. In the example of FIG. 8, a UE may have an XR packet of 1.0 Mbit arrive at its buffer ahead of Slot n, and so the UE is therefore able to transmit this XR packet using CG #1. Since the main CG-PUSCH of 0.5 Mbit, labelled as 1-0 in FIG. 8, is not sufficient to empty the UE buffer completely, the CG-UCI transmitted by the UE within the main CG-PUSCH 1-0 activates a supplementary CG-PUSCH 1-1 to carry the remaining 0.5 Mbit of data from the UE's buffer. Since supplementary CG-PUSCH 1-2 is not needed to transmit any of the XR packet, it is not activated by the UE, and hence can be used by the gNB to schedule other traffic or another UE.

It would be appreciated by those skilled in the art that the example of FIG. 8 exemplifies just one way in which supplementary CG-PUSCHs could be implemented, since the details of supplementary CG-PUSCH are not defined.

One of the pieces information that an XR device needs to transmit is its position and orientation (which can collectively be referred to as its pose) so that the XR application can determine the position at which the user is located and the direction the user is looking and respond appropriately (i.e., tracking of the XR Viewer pose). For example, if a VR headset displaying a virtual room sends pose information to the XR server suggesting the wearer of that VR headset is looking up, the server would display video of the ceiling of that virtual room rather than the floor. In addition to pose information, there may also be other types of control information that an XR device sends to the server on the uplink. Additionally, the XR device may transmit video and/or audio data so that it can be used by the counter-part of the XR user (such as the XR application server for example). Video and/or audio data typically require a large data size and are less time-sensitive. On the other hand, pose/control UL transmissions in XR are typically smaller in size and are a more time-sensitive nature. For example, if a person looks up and then looks down again, the video needs to display the ceiling and the floor accordingly in a timely manner. Since pose/control UL transmission is time-sensitive, if the UL transmission comprising such pose or control information fails, it may not be beneficial to retransmit that information again. For example, if a person looks up and then down, and the pose information when the person looks up fails to reach the server, there is not much benefit of retransmitting it again since by the time it is retransmitted the person may have already looked down and therefore no longer expects to see the ceiling. Recognising the nature of pose/control UL transmissions for services like XR, proposals have been made that such UL transmissions do not require HARQ retransmissions and, since they are small, they can be transmitted with very robust (i.e., low) MCSs thereby ensuring their reliability [10]. In addition, retransmission-less CG-PUSCH also has the benefits of both resource saving, since resources are not required to be used for retransmissions, and power saving, since the UE does not have to monitor for a potential retransmission from the gNB.

In [10], it is proposed that the configuredGrantTimer (T_{CG-ACK}) described above following discussion of FIG. 8 is set to zero for the main CG-PUSCH. That is, the UE times out the retransmission and flushes its HARQ buffer immediately after transmitting the main CG-PUSCH. In the current 3GPP system however, the minimum value of configuredGrantTimer is equal to one CG-PUSCH period. Hence, the current specifications do not allow a configuration where configuredGrantTimer=0. Introducing the value 0 to configuredGrantTimer would therefore have backward compatibility issues since legacy UEs may not understand the new value. A new timer would therefore needs to be introduced that would include the zero value, e.g., configuredGrantTimer_Rel18, which would only be understood by Rel-18 UEs supporting the retransmission-less feature. New behaviour will need to be introduced such that UE that the new timer overwrites the old timer. In the current 3GPP system, there are a maximum of 12 CG-PUSCH configurations and in this case, each of these CG-PUSCH configurations can independently configured the new timer parameter, that is the gNB can decide which CG-PUSCH is HARQ retransmission-less and which one requires HARQ retransmission, by setting the new timer to zero. So, this new timer is per CG configuration meaning that all HARQ processes with this CG-PUSCH would be set to zero. In other words, different HARQ processes within the same CG-PUSCH configuration cannot have a different value other than zero. This limits the flexibility of using this CG-PUSCH for other transmissions/services that require for retransmissions

In other applications, such as in a non-terrestrial network (NTN) system, the round-trip time (RTT) is very long and hence, in some operations, HARQ retransmissions are not practical since the UE has to wait a significant amount of time for an acknowledgement before it can flush its HARQ buffer. Recognising this, HARQ Mode B is introduced in NTN where for a configured set of HARQ Process Number (HPN), HARQ retransmission is disabled. It is proposed in that HARQ Mode B is also supported in terrestrial networks (TNs), thereby allowing CG-PUSCH to operate without HARQ retransmission. However, HARQ Mode B is configured on a per-HPN basis; that is, whether HARQ retransmission is used or not depends on the HPN of the PUSCH. This may be acceptable for dynamic PUSCH where the HPN is indicated by the gNB, but for CG-PUSCH the HPN is calculated depending upon the starting symbol of the CG-PUSCH transmission occasion and its periodicity, which is not easily controlled by the gNB or the UE, and so HARQ Mode B is not suitable for CG-PUSCH operation.

Another proposed approach for NTNs is disabling the HARQ RTT timer for retransmission-less CG-PUSCH, as introduced in Rel-17, but in a manner which is adapted for XR traffic. As such, a new RRC parameter may be introduced for disabling drx-HARQ-RTT-TimerUL for a particular CG-PUSCH configuration. However, this approach suffers from the same drawbacks as setting the configuredGrantTimer to zero, as described above, because disabling HARQ RTT timer per CG-PUSCH configuration means that all HARQ processes with this CG-PUSCH would be disabled. Hence this would limit the flexibility of using this CG-PUSCH for other transmissions/services that require for retransmissions.

### Retransmission-Less Indicator

One proposal which overcomes the deficiencies of the above-described approaches is to indicate dynamically (e.g. using a Retransmission-less indicator, referred to herein a retransmission indicator) in the UCI (e.g., CG-UCI) of a CG-PUSCH that denotes whether the current CG-PUSCH is HARQ retransmission-less or requires HARQ retransmission. This enables the UE to indicate per CG-PUSCH occasion whether that CG-PUSCH transmission requires HARQ retransmission or not. The benefit of this option is that it provides full flexibility of allowing any CG-PUSCH occasion (and not just particular CG-PUSCH configurations) to operate with or without HARQ retransmissions. However, one potential drawback of this approach is that a gNB and UE may become out-of-sync if the dynamic indication of the UCI is miss-detected. In other words, if the dynamic indication was included in a failed transmission, there is a higher likelihood that the gNB is not aware of whether the retransmission is expected by the UE or not.

As such, according to an example of the present disclosure, network infrastructure equipment (such as a gNB) determines that it will schedule uplink resources for retransmissions by a communications device (such as a UE) when the retransmission indicator cannot be decoded at the gNB. This e.g., might be the case when the gNB receives an uplink transmission in a particular uplink transmission occasion but is unable to decode the retransmission indicator. Similarly, this may occur when the gNB does not receive any transmission during the particular uplink transmission occasion and is unaware of whether retransmissions are required for the particular uplink transmission occasion (i.e. the gNB does not know the value of the retransmission indicator) for the communications device. In this way, the gNB defaults to scheduling uplink resources for retransmission (e.g. in the event of a failed transmission).

The retransmission indicator may be included in a CG-UCI which is included in a CG-PUSCH transmission but is independently encoded from the CG-PUSCH at the UE and decoded separately from the CG-PUSCH at the gNB. Hence, if the gNB cannot decode the CG-UCI, the gNB may schedule for retransmission for the CG-PUSCH, as it does not know whether or not UE has determined that the CG-PUSCH should be HARQ retransmission-less. In this case, if the UE triggered HARQ retransmission for the CG-PUSCH, the UE will monitor for HARQ retransmission signaling, which corresponds to the gNB default behavior. However, if the UE triggered the HARQ retransmission-less approach for the CG-PUSCH, the UE will not monitor for HARQ retransmission signaling. Although this results in an unnecessary waste of UL resources for scheduling retransmissions (which the UE does not intend to use), the occurrence of this wastage would be low as typically the CG-UCI (control information) has comparatively low coding rate (as compared to the data within the CG-PUSCH), such that the probability of misdetection of the CG-UCI is at least 0.01 (1%). As such, flexibility is provided by allowing individual CG-PUSCH occasions to be set with or without HARQ retransmissions, while ensuring that gNB and UE behavior remains synchronised in a manner which minimises resource wastage.

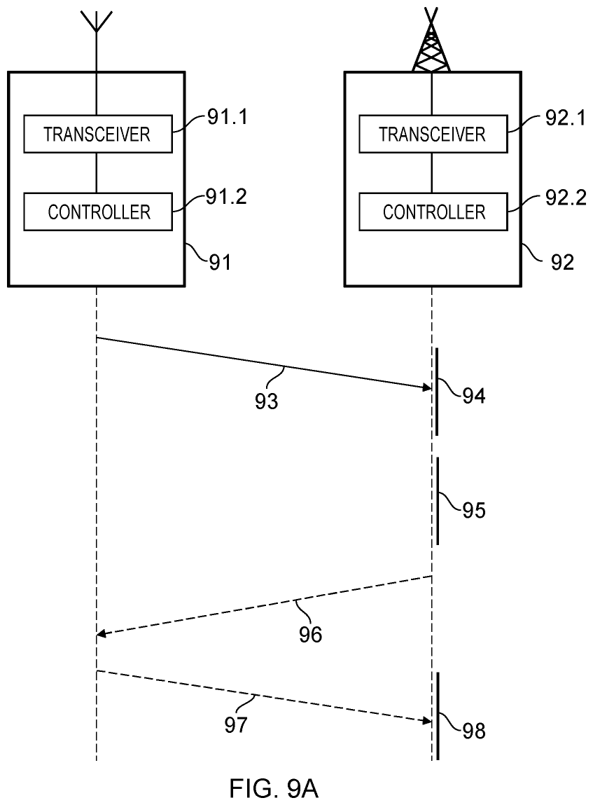

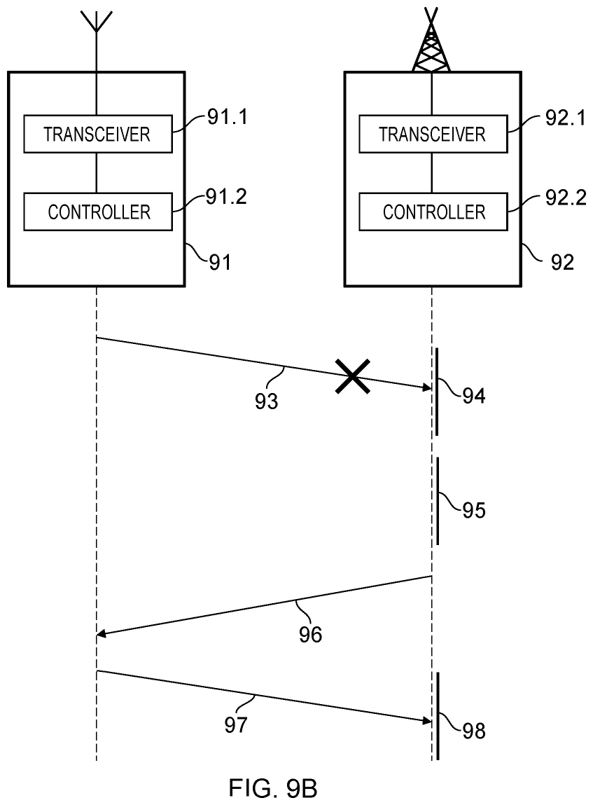

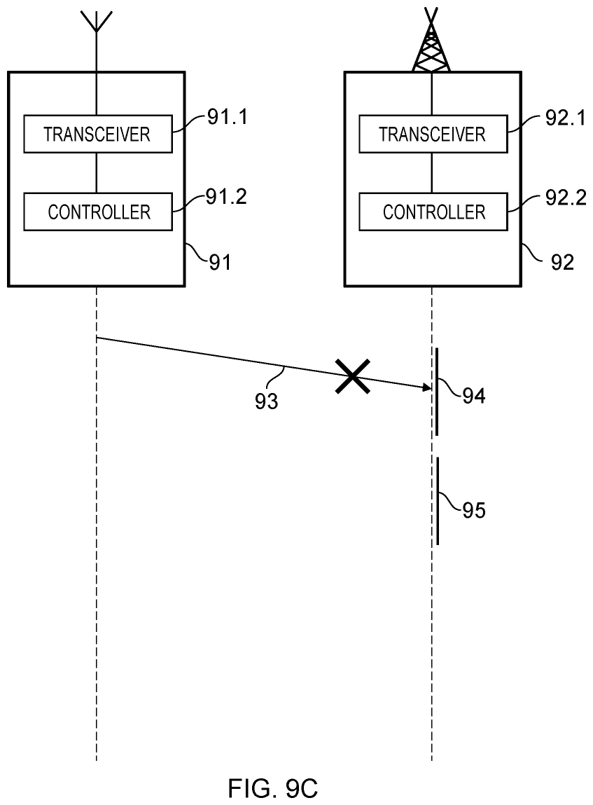

FIGS. 9A-C show examples of the above-described process. FIGS. 9A-C show part schematic, part message flow diagram representations of a first wireless communications system comprising a communications device 91 (e.g. a UE 14) and an infrastructure equipment 92 (e.g. a gNB 10) in accordance with at least some embodiments of the present technique. The communications device 91 is configured to transmit signals to and/or receive signals from the wireless communications network, for example, to and from the infrastructure equipment 92. Specifically, the communications device 91 may be configured to transmit data to and/or receive data from the wireless communications network (e.g. to/from the infrastructure equipment 92) via a wireless radio interface provided by the wireless communications network (e.g., a Uu interface between the communications device 91 and the Radio Access Network (RAN), which includes the infrastructure equipment 92). Such data transmitted by the communications device 91 may, for example, include data for applications such as XR. The communications device 91 and the infrastructure equipment 92 each comprise a transceiver (or transceiver circuitry) 91.1, 92.1, and a controller (or controller circuitry) 91.2, 92.2. Each of the controllers 91.2, 92.2 may be, for example, a microprocessor, a CPU, or a dedicated chipset, etc.

As shown in the example of FIG. 9A, the transceiver circuitry 91.1 and the controller circuitry 91.2 of the communications device 91 are configured in combination to transmit an uplink transmission 93 on an uplink channel in a first uplink transmission occasion 94, during which the transceiver circuitry 92.1 and the controller circuitry 92.2 of the infrastructure equipment 92 are configured to monitor the uplink channel for an uplink transmission from the communications device 91. In the example of FIG. 9A, the uplink transmission 93 is at least partially received by the infrastructure equipment 92 (such that the infrastructure equipment is able to at least determine that the uplink transmission 93 was sent by the communications device 91), which attempts 95 to identify a retransmission indicator associated with the first uplink transmission occasion 94. The infrastructure equipment 92 may attempt to identify the retransmission indicator associated with the first uplink transmission occasion 94 based on information included in the uplink transmission 93 and/or based on information included in one or more previous uplink transmissions. In some cases, the infrastructure equipment may be able to decode a retransmission indicator included in the uplink transmission 93, but may not be able to decode an entirety of the uplink transmission 93 (i.e. the uplink transmission 93 is only partially received by the infrastructure equipment 92).

Based on identifying the retransmission indicator associated with the first uplink transmission occasion 94, the infrastructure equipment 92 determines whether to schedule uplink resources for retransmission of the uplink transmission 93. If the retransmission indicator indicates that retransmissions are required, the infrastructure equipment 92 determines that it will schedule uplink resources for the communications device 91 to perform retransmission 97 of the uplink transmission. The infrastructure equipment 92 may transmit an UL Grant 96 (or other scheduling message) to the communications device 91, scheduling resources (e.g. a DG-PUSCH) for retransmission 97 of the uplink transmission 93 in a second uplink transmission occasion 98. The infrastructure equipment 92 then monitors for the retransmission 97 during the dynamically-scheduled second uplink transmission occasion 98. Conversely, if the retransmission indicator indicates that retransmissions are not required, the infrastructure equipment 92 determines not to schedule uplink resources for the communications device 91 to perform retransmission 97 of the uplink transmission, and the infrastructure equipment 92 does not monitor for the any retransmissions 97.

In some cases, as shown in FIGS. 9B and 9C, the uplink transmission 93 may not be received by the infrastructure equipment 93 and the infrastructure equipment 92 may be unable to identify a retransmission indicator associated with the first uplink transmission occasion 94. As such, the infrastructure equipment may be unaware of whether the communications device 91 has marked the uplink transmission 93 as retransmission-less or not. Therefore, according to the present example, the infrastructure equipment 92 determines that it will schedule uplink resources for the communications device 91 to perform retransmission 97 of the uplink transmission and may schedule and monitor uplink resources for retransmission of the uplink transmission 93, in the manner described above in relation to FIG. 9A.

In some cases, the infrastructure equipment 92 may be able to determine whether the uplink transmission occasion 94 included a failed transmission and may monitor for retransmissions accordingly. For example, the infrastructure equipment 92 may check for the presence of one or more demodulation reference signals (DMRS) during the uplink transmission occasion 94 by correlating any detected signals with known DMRS sequences. If a correlation peak is above the noise level (i.e., by using a defined threshold), the infrastructure equipment 92 determines that there was an uplink transmission during the uplink transmission occasion 94, but that this was not successfully decoded at the infrastructure equipment 92. If no DMRS is detected, the infrastructure equipment 92 may not necessarily conclude that no failed transmissions occurred during the uplink transmission occasion 94, and may attempt to determine this based on other factors (such as whether indications, in previous uplink transmission occasions, of the use of the uplink transmission occasion 94 for uplink transmissions, indications of the retransmission indicator for the uplink transmission occasion 94 in previous uplink transmission occasions, and/or whether indications of the use of an uplink transmission occasion configuration, corresponding to the uplink transmission occasion 94, for uplink transmissions).

In some cases, the uplink transmission 93 may not be received by the infrastructure equipment 93, however the infrastructure equipment 92 may nevertheless able to identify a retransmission indicator for the first uplink transmission occasion 94. For example, the retransmission indicator for the first uplink transmission occasion 94 may have been indicated to the infrastructure equipment 92 by the communications device 91 in an earlier uplink transmission occasion. The retransmission indicator may be either transmitted to the infrastructure equipment 92 (in any uplink transmission occasion, including the first uplink transmission occasion 94), or may be indicated to the infrastructure equipment 92 using one or more other parameters transmitted to the infrastructure equipment 92 (in any uplink transmission occasion, including the first uplink transmission occasion 94). For example, the infrastructure equipment 92 may identify the retransmission indicator based on a HARQ process number (HPN) or identifier, e.g. when the CG-PUSCH configuration is deployed in an unlicensed frequency spectrum. The indication of the retransmission indicator may be included in a CG-UCI or MAC CE of a CG-PUSCH.

The indication of the retransmission indicator may be indicated to the infrastructure equipment in multiple uplink transmission occasions. For example, in examples such as that illustrated in FIG. 8 above, an indication of the retransmission indicator for each CG-PUSCH and supplementary PUSCH occasion of a set of PUSCH occasions may be included in each PUSCH occasion of the set of PUSCH occasions. Alternatively, an indication of the retransmission indicator for each subsequent PUSCH occasion in a set of PUSCH occasions may be indicated in each PUSCH occasion of the set of PUSCH occasions. As such, a single missed detection of the CG-UCI or MAC CE of a CG-PUSCH is unlikely to result in the infrastructure equipment becoming unaware of whether the communications device has requested retransmission, thereby further minimising resource wastage.

In addition to an uplink transmission occasion including an indication of a retransmission indicator for future uplink transmission occasions, an uplink transmission occasion may additionally or alternatively include an indication of a retransmission indicator for previous uplink transmission occasions. As such, the infrastructure equipment may be able to determine whether any changes to transmission parameters (e.g. transmission power) of the communications device are required, based e.g. on whether the previous uplink transmission occasion required retransmission and whether the uplink transmission was successfully decoded at the infrastructure equipment.

Additionally or alternatively, the communications device may indicate whether a particular uplink transmission occasion is used for any uplink transmissions. That is, an uplink transmission may indicate whether a future (and/or past) uplink transmission occasion is used for transmitting an uplink transmission. As such, the infrastructure equipment may be able to better determine whether any failed transmissions occurred and therefore whether retransmission may be required. For example, CG-Uplink Control Information (UCI) may be included in every transmitted CG-PUSCH, where the CG-UCI indicates whether the future CG-PUSCH occasions are used or not. In other words, the CG-UCI contains an indication of unused CG-PUSCH occasions (i.e., supplementary CG-PUSCH occasions) in a period of a single CG-PUSCH configuration.

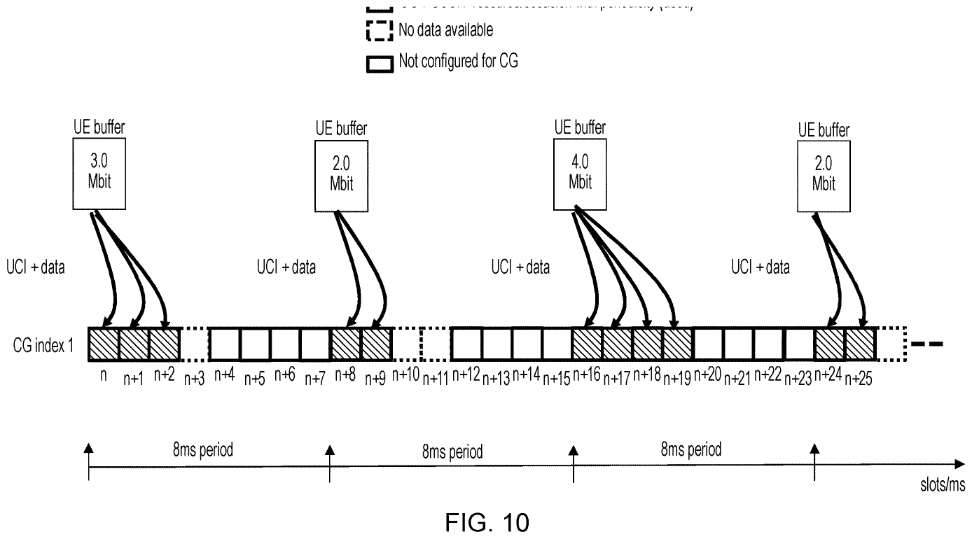

An example of this process is shown in FIG. 10, where a UE is configured with a single CG-PUSCH index 1, having a periodicity of 8 ms or 8 slots. In the first period of 8 slots, there are four occasions (n to n+3) configured to be used for data transmission. Hence, based on the available data (around 3 Mbit), the UE estimates that uplink data will occupy only in three occasions/slots n, n+1 and n+2. Therefore, the UE includes UCI in every transmitted PUSCH in occasions/slots n, n+1 and n+2, where the UCI indicates that there is no data to be transmitted during the last occasion of n+3. Based on that information, if the gNB does not decode CG-PUSCH/UCI on a particular one of occasions/slots n, n+1 or n+2, the gNB can rely on the UCI information transmitted on a different occasion/slot which has indicated that there will be transmission on occasions/slots n+1 and n+2. Hence, the gNB is able to determine whether there is a failed transmission, and then schedule uplink resources for retransmission for the PUSCH, as it does not know whether the UE has triggered HARQ retransmissions or retransmission-less for the transmitted (and unsuccessfully decoded) PUSCH. Similar processes apply during the second and fourth periods shown in FIG. 10.

Additionally or alternatively, the communications device may indicate whether a particular uplink transmission occasion configuration is used for any uplink transmissions. As discussed above, a communications device can be configured with multiple uplink transmission occasion (e.g. CG-PUSCH) configuration, in some cases up to 12 different configurations. The communications device may indicate to the infrastructure equipment that a particular configuration (i.e. all uplink transmission occasions having that configuration) is not used for uplink transmissions. This may be indicated in CG-PUSCH occasions having the same or different configuration as the particular CG-PUSCH occasion configuration indicated. As such, the infrastructure equipment can determine that a specific uplink transmission occasion having the particular configuration did not include an uplink transmission, and thus that no failed transmissions occurred during the uplink transmission occasion.

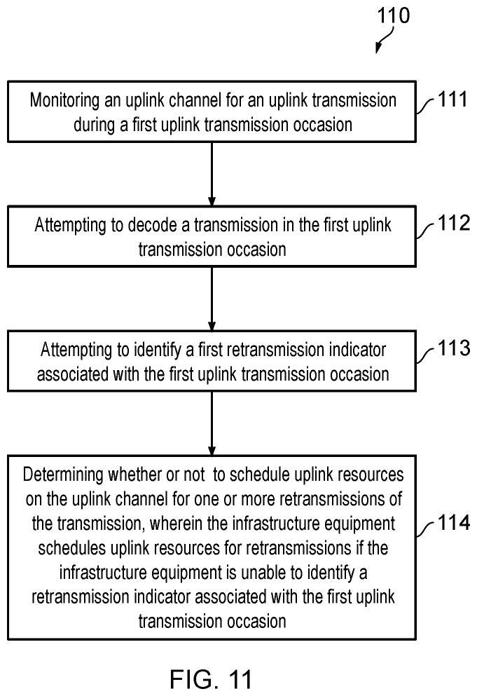

FIG. 11 shows a flowchart of a method 110 of operating an infrastructure equipment according to an example of the present disclosure. At step 111, the infrastructure equipment monitors an uplink channel for a transmission from a communications device during a first uplink transmission occasion. At step 112, the infrastructure equipment attempts to decode the transmission from the communications device in the first uplink transmission occasion. At step 113, the infrastructure equipment attempts to identify a first retransmission indicator associated with the first uplink transmission occasion. At step 114, the infrastructure equipment determines, based on the attempting to identify the first retransmission indicator associated with the first uplink transmission occasion, whether or not to schedule uplink resources on the uplink channel for one or more retransmissions of the transmission, wherein if the infrastructure equipment is unable to identify a retransmission indicator associated with the first uplink transmission occasion, the infrastructure equipment schedules uplink resources for the communications device to transmit the one or more retransmissions of the first transmission that the infrastructure equipment fails to decode.

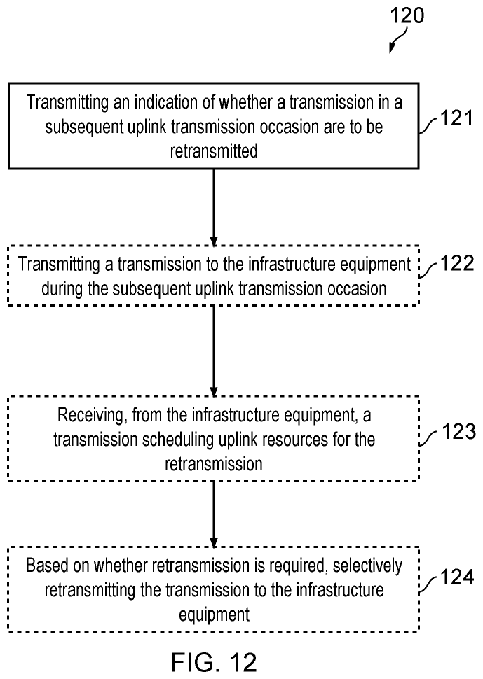

FIG. 12 shows a flowchart of a method 120 of operating a communications device according to an example of the present disclosure. At step 121, the communications device transmits to the infrastructure equipment and during a first uplink transmission occasion, an indication of whether transmissions in a second uplink transmission occasion occurring subsequent to the first uplink transmission occasion are to be retransmitted. At step 122, the communications device optionally transmits a first transmission to the infrastructure equipment, the first transmission including uplink data. At step 123, the communications device optionally receives, from the infrastructure equipment, a transmission scheduling uplink resources for retransmission of the first transmission. At step 124, the communications device optionally, based on whether transmissions in the second uplink transmission occasion are to be retransmitted, retransmits the uplink data (i.e. retransmits the first transmission) using the scheduled uplink resources.

The following numbered clauses provide further example aspects and features of the present technique:

1. A method of operating an infrastructure equipment forming part of a wireless communications network configured to transmit signals to and/or to receive signals from a communications device via a wireless access interface, the method comprising:
monitoring an uplink channel for a transmission from a communications device during a first uplink transmission occasion; and
attempting to decode the transmission from the communications device in the first uplink transmission occasion; and
attempting to identify a first retransmission indicator associated with the first uplink transmission occasion;
determining, based on the attempting to identify the first retransmission indicator associated with the first uplink transmission occasion, whether or not to schedule uplink resources on the uplink channel for one or more retransmissions of the transmission,
wherein if the infrastructure equipment is unable to identify a retransmission indicator associated with the first uplink transmission occasion, the infrastructure equipment schedules uplink resources for the communications device to transmit the one or more retransmissions of the first transmission that the infrastructure equipment fails to decode.

2. The method according to clause 1, wherein attempting to decode the transmission comprises attempting to detect one or more demodulation reference signals during the first uplink transmission occasion.

3. The method according to clause 1 or clause 2, wherein the infrastructure equipment does not detect a transmission during the first uplink transmission occasion.

4. The method according to clause 3, further comprising determining whether the first uplink transmission occasion contained a transmission from the communications device that was not successfully decoded by the infrastructure equipment.

5. The method according to clause 4, wherein the infrastructure equipment determines whether the first uplink transmission occasion contained a transmission from the communications device that was not successfully decoded by the infrastructure equipment based on receiving, from the communications device and during a transmission occasion prior to the first uplink transmission occasion, an indication of whether the first uplink transmission occasion includes a first transmission from the communications device.

6. The method of clause 4 or 5, wherein the infrastructure equipment determines whether the first uplink transmission occasion contained a transmission from the communications device that was not successfully decoded by the infrastructure equipment based on receiving, from the communications device and during a transmission occasion prior to the first uplink transmission occasion, an indication of whether with a particular uplink transmission occasion configuration of a plurality of uplink transmission occasion configurations includes any transmissions from the communications device, wherein the first uplink transmission occasion has the particular uplink transmission occasion configuration.

7 The method according to clause 1 or clause 2, wherein the infrastructure equipment detects a first transmission during the first uplink transmission occasion.

8. The method according to clause 7, further comprising:
identifying the first retransmission indicator associated with the first uplink transmission occasion;
based on determining that the first retransmission indicator indicates that one or more retransmissions of the first transmission are to be performed, scheduling uplink resources for the communications device to transmit the one or more retransmissions of the first transmission.

9. The method according to clause 7, further comprising:
identifying the first retransmission indicator associated with the first uplink transmission occasion;
based on determining that the first retransmission indicator indicates that one or more retransmissions of the first transmission are not to be performed, determining not to schedule uplink resources for the communications device to transmit the one or more retransmissions of the first transmission.

10. The method according to any of clauses 7-9, wherein the infrastructure equipment identifies the first retransmission indicator based on receiving the first retransmission indicator in the first transmission.

11. The method according to any of clauses 7-10, wherein the first transmission includes a second retransmission indicator for a second transmission occasion occurring subsequent to the first transmission occasion.

12. The method according to any of clauses 7-11, wherein the first transmission includes a third retransmission indicator for a third transmission occasion occurring prior to the first transmission occasion.

13. The method according to clause 12, further comprising: determining, based on the third retransmission indicator and whether a transmission was detected during the third transmission occasion, a modification to one or more transmission parameters of the communications device.

14. The method according to any preceding clause, further comprising: identifying the first retransmission indicator associated with the first uplink transmission occasion based on receiving, from the communications device and during a transmission occasion prior to the first uplink transmission occasion, the retransmission indicator associated with the first uplink transmission occasion.

15. The method according to any preceding clause, further comprising: identifying the first retransmission indicator associated with the first uplink transmission occasion based on receiving, from the communications device and during a transmission occasion prior to the first uplink transmission occasion, the retransmission indicator associated with a particular uplink transmission occasion configuration of a plurality of uplink transmission occasion configurations, wherein the first uplink transmission occasion has the particular uplink transmission occasion configuration.

16. The method according to any preceding clause, wherein an indication of the retransmission indicator is included in uplink control information received from the communications device.

17. The method according to any preceding clause, wherein an indication of the retransmission indicator is included in a MAC control element (CE) received from the communications device.

18. The method according to clause 16 or clause 17, wherein the indication of the retransmission indicator is included in a physical uplink shared channel transmission.

19. The method according to any preceding clause, wherein attempting to identify a first retransmission indicator associated with the first uplink transmission occasion comprises deriving a value of the retransmission indicator based on one or more other parameters included in uplink control information received from the communications device.

20. The method according to clause 19, wherein the one or more other parameters include a HARQ process number (HPN) or identifier, and wherein the first uplink transmission occasion occurs in an unlicensed frequency spectrum.

21. An infrastructure equipment comprising:
a transceiver configured to transmit signals to and/or to receive signals from a communications device via a wireless radio interface provided by the infrastructure equipment, and
   a controller configured in combination with the transceiver to:
   monitor an uplink channel for a transmission from a communications device during a first uplink transmission occasion; and
   attempt to decode the transmission from the communications device in the first uplink transmission occasion; and
   attempt to identify a first retransmission indicator associated with the first uplink transmission occasion;
   determine, based on the attempting to identify the first retransmission indicator associated with the first uplink transmission occasion, whether or not to schedule uplink resources on the uplink channel for one or more retransmissions of the transmission,
   wherein the infrastructure equipment is configured to: if the infrastructure equipment is unable to identify a retransmission indicator associated with the first uplink transmission occasion, schedule uplink resources for the communications device to transmit the one or more retransmissions of the first transmission that the infrastructure equipment fails to decode.

22. Circuitry for an infrastructure equipment, the circuitry comprising:
transceiver circuitry configured to transmit signals to and/or to receive signals from a communications device via a wireless radio interface provided by the infrastructure equipment, and
controller circuitry configured in combination with the transceiver circuitry to:
monitor an uplink channel for a transmission from a communications device during a first uplink transmission occasion; and
attempt to decode the transmission from the communications device in the first uplink transmission occasion; and
attempt to identify a first retransmission indicator associated with the first uplink transmission occasion;
determine, based on the attempting to identify the first retransmission indicator associated with the first uplink transmission occasion, whether or not to schedule uplink resources on the uplink channel for one or more retransmissions of the transmission,
wherein the infrastructure equipment is configured to: if the infrastructure equipment is unable to identify a retransmission indicator associated with the first uplink transmission occasion, schedule uplink resources for the communications device to transmit the one or more retransmissions of the first transmission that the infrastructure equipment fails to decode.

23. A method of operating a communications device configured to transmit signals to and/or to receive signals from an infrastructure equipment of a wireless communications network via a wireless access interface, the method comprising:
transmitting, to the infrastructure equipment and during a first uplink transmission occasion, an indication of whether transmissions in a second uplink transmission occasion occurring subsequent to the first uplink transmission occasion are to be retransmitted.

24. The method according to clause 23, wherein the indication of whether transmissions in a second uplink transmission occasion are to be retransmitted includes a retransmission indicator associated with the second uplink transmission occasion.

25. The method according to clause 23 or clause 24, wherein the indication of whether transmissions in a second uplink transmission occasion are to be retransmitted includes an indication of whether the communications device will utilise the second uplink transmission occasion for any uplink transmissions.

26. The method according to any of clauses 23-25, wherein the indication of whether transmissions in a second uplink transmission occasion are to be retransmitted includes a retransmission indicator associated with a particular uplink transmission occasion configuration of a plurality of uplink transmission occasion configurations, wherein the second uplink transmission occasion has the particular uplink transmission occasion configuration.

27 The method according to any of clauses 23-26, wherein the indication of whether transmissions in a second uplink transmission occasion are to be retransmitted includes an indication of whether the communications device will utilise a particular uplink transmission occasion configuration of a plurality of uplink transmission occasion configurations for any uplink transmissions, wherein the second uplink transmission occasion has the particular uplink transmission occasion configuration.

28. The method according to any of clauses 23-27, wherein the indication indicates that transmissions in the second uplink transmission occasion are to be retransmitted, and wherein the method further comprises:
transmitting, to the infrastructure equipment and during the second uplink transmission occasion, a first transmission;
receiving, from the infrastructure equipment, a transmission scheduling uplink resources for retransmission of the first transmission; and
retransmitting the first transmission to the infrastructure equipment using the scheduled uplink resources.

29. The method according to any of clauses 23-27, wherein the indication indicates that transmissions in the second uplink transmission occasion are not to be retransmitted, and wherein the method further comprises:
transmitting, to the infrastructure equipment and during the second uplink transmission occasion, a first transmission;
   receiving, from the infrastructure equipment, a transmission scheduling uplink resources for retransmission of the first transmission; and
determining not to utilise the scheduled uplink resources for retransmission of the first transmission.

30. A communications device comprising:
a transceiver configured to transmit signals to and/or to receive signals from an infrastructure equipment of a wireless communications network via a wireless radio interface provided by the wireless communications network, and
a controller configured in combination with the transceiver to:
   transmit, to the infrastructure equipment and during a first uplink transmission occasion, an indication of whether transmissions in a second uplink transmission occasion occurring subsequent to the first uplink transmission occasion are to be retransmitted.

31. Circuitry for a communications device comprising:
transceiver circuitry configured to transmit signals to and/or to receive signals from an infrastructure equipment of a wireless communications network via a wireless radio interface provided by the wireless communications network, and
controller circuitry configured in combination with the transceiver circuitry to:
transmit, to the infrastructure equipment and during a first uplink transmission occasion, an indication of whether transmissions in a second uplink transmission occasion occurring subsequent to the first uplink transmission occasion are to be retransmitted.

Accordingly, from one perspective, there has been described methods, infrastructure equipment and communications devices for robustly signalling whether retransmissions are required for a particular uplink transmission occasion. A communications device indicates in an earlier uplink occasion whether retransmissions are required for a particular uplink transmission occasion and an infrastructure equipment selectively schedules uplink resources for retransmissions based on the indication from the communications device. If the infrastructure equipment is unable to determine whether retransmissions are required for a particular uplink transmission occasion, the infrastructure equipment schedules the uplink resources for the particular uplink transmission occasion.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, third Generation Partnership Project, v14.3.0.
[3] RP-190726, “Physical layer enhancements for NR ultra-reliable and low latency communication (URLLC)”, Huawei, HiSilicon, RAN #83.
[4] RP-201310, “Revised WID: Enhanced Industrial Internet of Things (IoT) and ultra-reliable and low latency communication (URLLC) support for NR,” Nokia, Nokia Shanghai Bell, RAN #88e.
[5] RP-191575, “NR-based Access to Unlicensed Spectrum”, Qualcomm, RAN #84.
[6] RP-220285, “Revised SID: Study on XR Enhancements for NR”, Nokia, RAN #95e.
[7] R2-2302309 (TR38.835), “Study on XR enhancements for NR”, v1.0.2.
[8] TR 38.838, “Study on XR (Extended Reality) Evaluations for NR (Release 17)”, v17.0.0.
[9] International patent application with publication number WO 2022/018230. R1-2210002, “Power Saving Techniques for XR”, Qualcomm, RAN1 #110bis-e.

1. A method of operating an infrastructure equipment forming part of a wireless communications network configured to transmit signals to and/or to receive signals from a communications device via a wireless access interface, the method comprising:
monitoring an uplink channel for a transmission from a communications device during a first uplink transmission occasion;
attempting to decode the transmission from the communications device in the first uplink transmission occasion;
attempting to identify a first retransmission indicator associated with the first uplink transmission occasion; and
determining, based on the attempting to identify the first retransmission indicator associated with the first uplink transmission occasion, whether or not to schedule uplink resources on the uplink channel for one or more retransmissions of the transmission,
wherein if the infrastructure equipment is unable to identify a retransmission indicator associated with the first uplink transmission occasion, the infrastructure equipment schedules uplink resources for the communications device to transmit the one or more retransmissions of the first transmission that the infrastructure equipment fails to decode.

2. The method according to claim 1, wherein attempting to decode the transmission comprises attempting to detect one or more demodulation reference signals during the first uplink transmission occasion.

3. The method according to claim 1, wherein the infrastructure equipment does not detect a transmission during the first uplink transmission occasion.

4. The method according to claim 3, further comprising determining whether the first uplink transmission occasion contained a transmission from the communications device that was not successfully decoded by the infrastructure equipment.

5. The method according to claim 4, wherein the infrastructure equipment determines whether the first uplink transmission occasion contained a transmission from the communications device that was not successfully decoded by the infrastructure equipment based on receiving, from the communications device and during a transmission occasion prior to the first uplink transmission occasion, an indication of whether the first uplink transmission occasion includes a first transmission from the communications device.

6. The method of claim 4, wherein the infrastructure equipment determines whether the first uplink transmission occasion contained a transmission from the communications device that was not successfully decoded by the infrastructure equipment based on receiving, from the communications device and during a transmission occasion prior to the first uplink transmission occasion, an indication of whether with a particular uplink transmission occasion configuration of a plurality of uplink transmission occasion configurations includes any transmissions from the communications device, wherein the first uplink transmission occasion has the particular uplink transmission occasion configuration.

7. The method according to claim 1, wherein the infrastructure equipment detects a first transmission during the first uplink transmission occasion.

8. The method according to claim 7, further comprising:
identifying the first retransmission indicator associated with the first uplink transmission occasion;
based on determining that the first retransmission indicator indicates that one or more retransmissions of the first transmission are to be performed, scheduling uplink resources for the communications device to transmit the one or more retransmissions of the first transmission.

9. The method according to claim 7, further comprising:
identifying the first retransmission indicator associated with the first uplink transmission occasion;
based on determining that the first retransmission indicator indicates that one or more retransmissions of the first transmission are not to be performed, determining not to schedule uplink resources for the communications device to transmit the one or more retransmissions of the first transmission.

10. The method according to claim 7, wherein the infrastructure equipment identifies the first retransmission indicator based on receiving the first retransmission indicator in the first transmission.

11. The method according to claim 7, wherein the first transmission includes a second retransmission indicator for a second transmission occasion occurring subsequent to the first transmission occasion.

12. The method according to claim 7, wherein the first transmission includes a third retransmission indicator for a third transmission occasion occurring prior to the first transmission occasion.

13. The method according to claim 12, further comprising:
determining, based on the third retransmission indicator and whether a transmission was detected during the third transmission occasion, a modification to one or more transmission parameters of the communications device.

14. The method according to claim 1, further comprising:
identifying the first retransmission indicator associated with the first uplink transmission occasion based on receiving, from the communications device and during a transmission occasion prior to the first uplink transmission occasion, the retransmission indicator associated with the first uplink transmission occasion.

15. The method according to claim 1, further comprising:
identifying the first retransmission indicator associated with the first uplink transmission occasion based on receiving, from the communications device and during a transmission occasion prior to the first uplink transmission occasion, the retransmission indicator associated with a particular uplink transmission occasion configuration of a plurality of uplink transmission occasion configurations, wherein the first uplink transmission occasion has the particular uplink transmission occasion configuration.

16. The method according to claim 1, wherein an indication of the retransmission indicator is included in uplink control information received from the communications device.

17. The method according to claim 1, wherein an indication of the retransmission indicator is included in a MAC control element (CE) received from the communications device.

18. (canceled)

19. The method according to claim 1, wherein attempting to identify a first retransmission indicator associated with the first uplink transmission occasion comprises deriving a value of the retransmission indicator based on one or more other parameters included in uplink control information received from the communications device.

20. (canceled)

21. An infrastructure equipment comprising:
a transceiver configured to transmit signals to and/or to receive signals from a communications device via a wireless radio interface provided by the infrastructure equipment, and
a controller configured in combination with the transceiver to:
monitor an uplink channel for a transmission from a communications device during a first uplink transmission occasion;
attempt to decode the transmission from the communications device in the first uplink transmission occasion;
attempt to identify a first retransmission indicator associated with the first uplink transmission occasion; and
determine, based on the attempting to identify the first retransmission indicator associated with the first uplink transmission occasion, whether or not to schedule uplink resources on the uplink channel for one or more retransmissions of the transmission,
wherein the infrastructure equipment is configured to: if the infrastructure equipment is unable to identify a retransmission indicator associated with the first uplink transmission occasion, schedule uplink resources for the communications device to transmit the one or more retransmissions of the first transmission that the infrastructure equipment fails to decode.

22.-30. (canceled)

31. A communications device comprising:
a transceiver configured to transmit signals to and/or to receive signals from an infrastructure equipment of a wireless communications network via a wireless radio interface provided by the wireless communications network, and
a controller configured in combination with the transceiver to:
transmit, to the infrastructure equipment and during a first uplink transmission occasion, an indication of whether transmissions in a second uplink transmission occasion occurring subsequent to the first uplink transmission occasion are to be retransmitted.

32. (canceled)
